(19) United States
(12) Patent Application Publication
(10) Pub. No.: US 2021/0347397 A1
(43) Pub. Date: Nov. 11, 2021

(54) RIDE-ON TOY FOR CHILDREN

(71) Applicant: Headstart International Pty Ltd, Victoria (AU)

(72) Inventor: Richard de Stoop, Victoria (AU)

(21) Appl. No.: 17/244,057

(22) Filed: Apr. 29, 2021

(30) Foreign Application Priority Data
Apr. 30, 2020 (AU) 2020901366

(51) Int. Cl. B62B 3/00; B62B 3/02; B62B 5/06

(52) U.S. Cl. CPC B62B 3/007; B62B 5/067; B62B 3/02

(57) ABSTRACT

A ride-on toy can include a body having a shape resembling a torso of a creature and suitable for being sat on by a child, and four walking mechanisms connected to the body. Each walking mechanism can include a wheel rotatably mounted to the body at a wheel center, and a leg slidably connected to the body via a peg received in a slot defined by the body. The leg includes a foot and has a shape resembling a leg of the creature. The foot is eccentrically linked to the wheel. Two out of the four walking mechanisms are connected to a head end of the body to define a pair of forelegs. The other two out of the four walking mechanisms are connected to a tail end of the body to define a pair of hind legs.

### TECHNICAL FIELD

The present disclosure relates to children's toys; in particular, wheeled toys which can be ridden or rolled along the ground by a child.

### BACKGROUND

Ride-on toys allow a child to sit on the toy and propel the toy forwards or backwards by pushing with their legs on the ground.

It is desired to address or ameliorate one or more shortcomings of ride-on toys, or to at least provide a useful alternative thereto.

### SUMMARY

Some embodiments relate to a ride-on toy, comprising:

a body having a shape resembling a torso of a creature and suitable for being sat on by a child; and

four walking mechanisms connected to the body, each walking mechanism comprising:
a wheel rotatably mounted to the body at a wheel centre; and
a leg slidably connected to the body via a peg received in a slot defined by the body, the leg comprising a foot and having a shape resembling a leg of the creature;
wherein the foot is eccentrically linked to the wheel; and
wherein rotation of the wheel is converted into orbital movement of the foot about the wheel centre and reciprocating movement of the leg along the slot;

wherein two out of the four walking mechanisms are connected to a head end of the body to define a pair of forelegs; and

wherein the other two out of the four walking mechanisms are connected to a tail end of the body to define a pair of hind legs.

Each one of the wheels may be independently rotatably mounted to the body, so that rotation of any one of the wheels moves only the leg and foot connected to that wheel.

The toy may further comprise a seat connected to a midsection of the body defined between the head and tail ends, wherein the seat may be movable between a seated position and a tilted position. The seat may comprise at least one handle for the child to hold on to for support while walking. A portion of the midsection may be widened relative to the head and tail ends of the body.

The toy may further comprise a head of the creature and a tail of the creature, wherein the head is connected to the head end of the body, and wherein the tail is connected to the tail end of the body. The head may comprise a handle portion for the child to hold on to while seated on the toy.

Throughout the orbital movement of the foot about the wheel centre as the wheel rotates, the foot may remain offset from a ground-engaging portion of the wheel. Each one of the wheels may be located between the body and the foot connected to that wheel.

### BRIEF DESCRIPTION OF DRAWINGS

Embodiments are described in further detail below, by way of example, with reference to the accompanying drawings, in which:

FIG. 1A is a perspective view of a ride-on toy suitable for a child to sit on, according to some embodiments;

FIG. 1B shows a child sitting on the ride-on toy of FIG. 1A;

FIG. 1C is a perspective view of the ride-on toy of FIG. 1A, the toy configurable to be in a “walker” mode as shown according to some embodiments;

FIG. 2 is an exploded perspective view of the ride-on toy of FIG. 1A, according to some embodiments;

FIG. 3 is a partial section view showing the operation of the ride-on toy of FIG. 1A, according to some embodiments;

FIG. 4 is a plan view of the ride-on toy of FIG. 1A, according to some embodiments;

FIG. 5 is an underside view of the ride-on toy of FIG. 1A, according to some embodiments; and

FIG. 6 is a perspective underside view of the ride-on toy of FIG. 1A, according to some embodiments.

FIG. 7A is a perspective view of the ride-on toy incorporating a handle suitable for use in the “walker” mode, according to some embodiments.

FIG. 7B is a perspective view of the ride-on toy of FIG. 7A in the “walker” mode, according to some embodiments.

FIG. 8 is a side view of the ride-on toy of FIG. 7A, according to some embodiments.

### DETAILED DESCRIPTION

The present disclosure relates to children's toys; in particular, wheeled toys which can be ridden or rolled along the ground by a child. Embodiments do not have any pedals or other means of driving the toy forward other than by pushing on the ground.

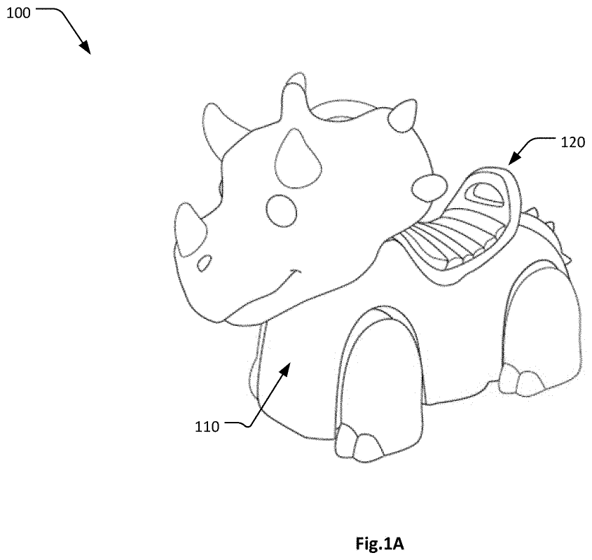

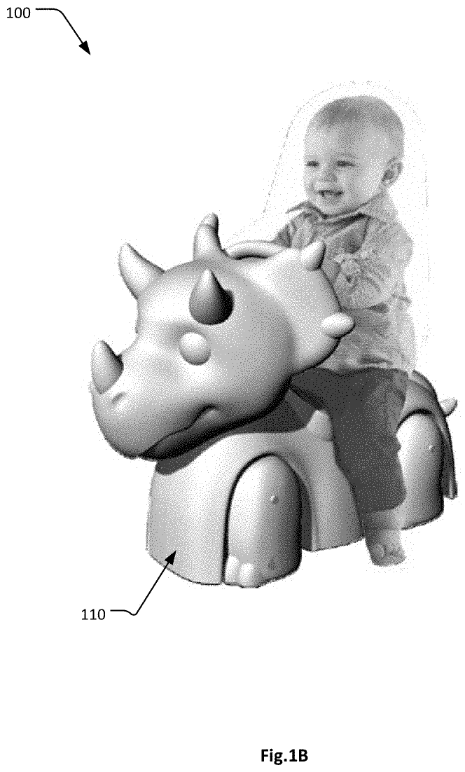

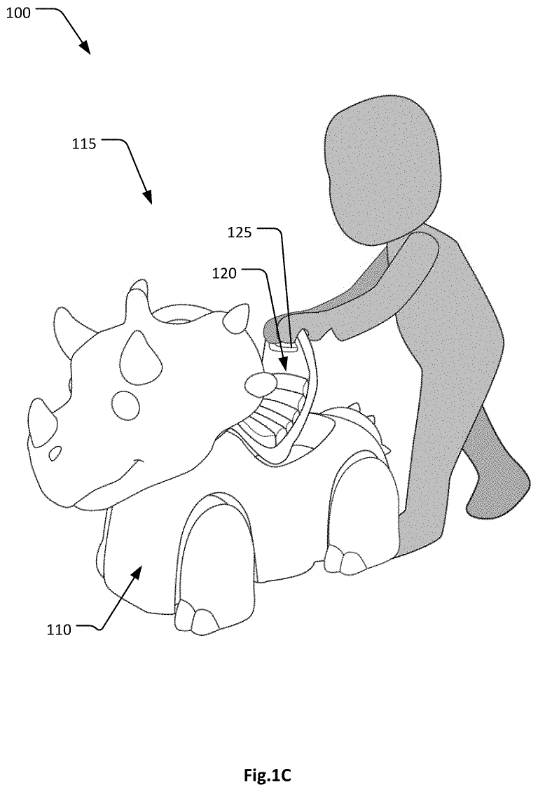

FIG. 1A shows an embodiment of a ride-on toy 100 suitable for a child to sit on. The ride-on toy 100 comprises a body 110 having a shape resembling a torso of a creature and suitable for being sat on by a child. The toy 100 may have a designated seat 120. The creature may be an animal, such as a horse, a dog, a lion, or a bear. In some embodiments, the creature is a fictional or extinct character such as a dinosaur or a unicorn, or a cartoon character for example.

In FIG. 1B, a child is shown sitting on the ride-on toy 100. For the child to operate the toy 100, at least one of the child's legs must be able to contact the ground while the child is seated on the toy 100, so as to propel the toy 100 forwards or backwards by pushing with at least one of their legs on the ground.

In some embodiments, such as shown in FIG. 1C, the ride-on toy 100 is convertible to be used as a walker. In the “walker” mode 115, the toy provides walking support or assistance to the child. The toy 100 may have a handle 125 or other structure to allow the child to reach forward and hold or lean on for support while walking, and thereby pushing the toy 100 along the ground. The handle 125 may be folded away or otherwise remain out of the way when the toy 100 is in a “rider” mode 130, such as shown in FIG. 1B, so that the child may sit on the toy 100 without the handle 125 interfering with operation. In some embodiments, the handle 125 is disposed at a rear portion of the seat 120. The handle 125 may extend somewhat upwardly at an angle to the rest of the seat.

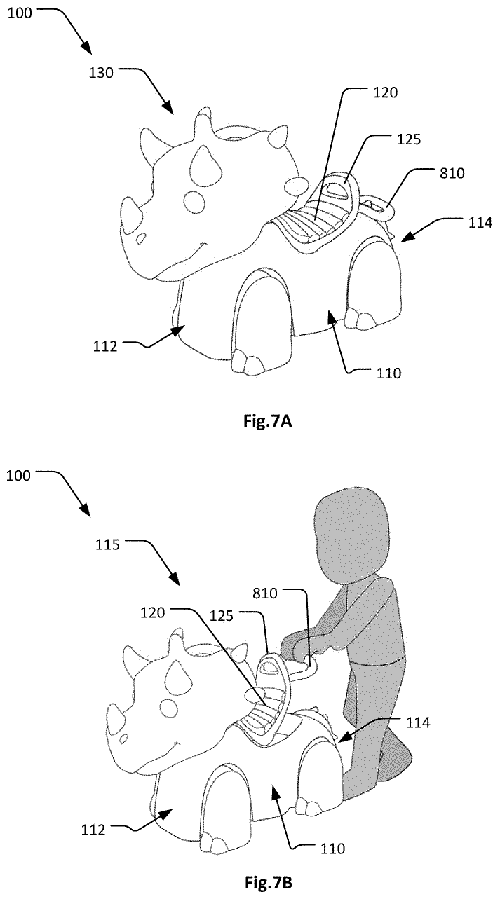

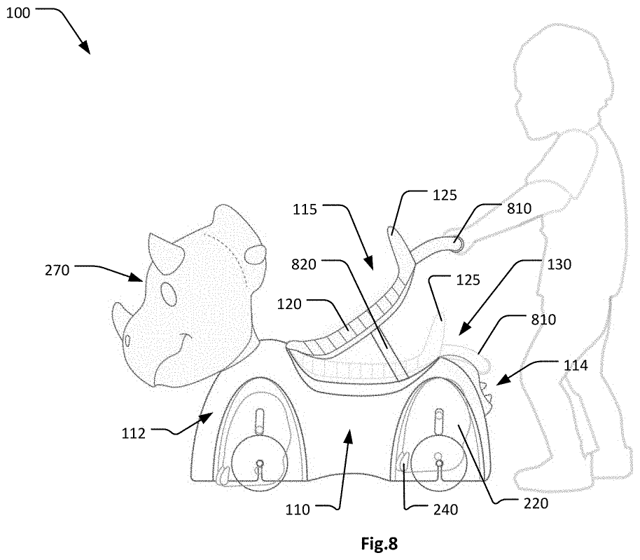

In some embodiments, such as shown in FIGS. 7A-8, the ride-on toy 100 comprises a second handle 810 disposed at the rear portion of the seat 120 and extending over a rear portion of the body 110. The second handle 810 is positioned rearward of the handle 125 so that when the toy 100 is in the “walker” mode 115 (FIG. 7B), the child standing behind the toy 100 only has to reach forward a limited amount to hold onto the second handle 810. If the child prefers to reach further forward, they may hold onto the handle 125. In conjunction with the handle 125, the second handle 810 allows the child to choose where to place their hand(s). When the ride-on toy 100 is in the “rider” mode 130 (FIG. 7A), the second handle 810 may extend over the tail end 114 of the body, as shown by the light outline in FIG. 8. In some embodiments, the handle 125 may be omitted and only the handle 810 extending rearwardly from the rear end of the seat may be provided.

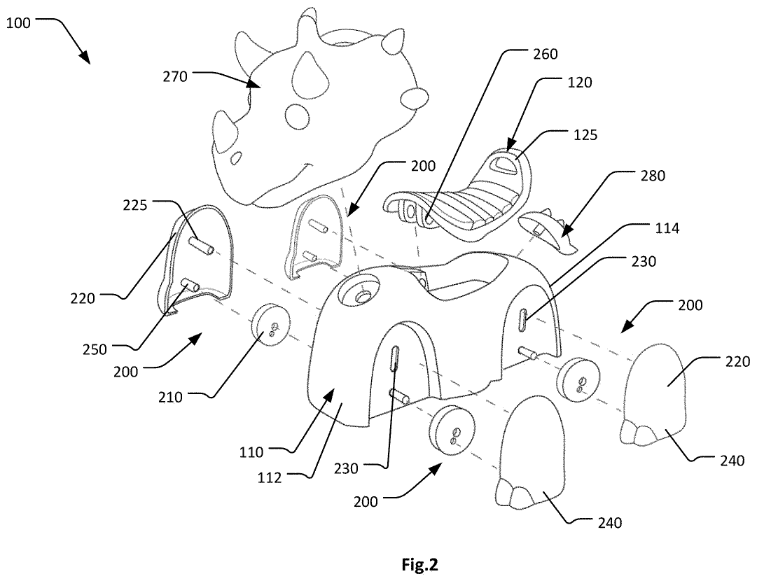

Turning now to FIG. 2, the ride-on toy 100 further comprises a walking mechanism 200 connected to the body. The dashed lines of FIG. 2 show how the various components of the walking mechanism 200 are assembled and interact with each other. In some embodiments, the ride-on toy 100 comprises four walking mechanisms 200 connected to the body, wherein two out of the four walking mechanisms 200 are connected to a head end 112 of the body 110 to define a pair of forelegs and the other two out of the four walking mechanisms are connected to a tail end 114 of the body 110 to define a pair of hind legs, so that the toy generally resembles a quadruped.

Each walking mechanism 200 comprises a wheel 210 rotatably mounted to the body at the wheel centre, such as via an axle, and a leg 220 slidably connected to the body 110 via a peg 225 received in a slot 230 defined by the body 110.

The leg 220 comprises a foot 240 and has a shape resembling a leg of the creature or animal. In some embodiments, the foot 240 is rigidly connected to the leg 220 (i.e. no ankle articulation) so that any movement of the foot 240 immediately causes movement of the leg 220, and vice versa.

For stability when the ride-on toy 100 is placed on the ground, the ride-on toy 100 comprises at least three wheels. In some three-wheeled embodiments of the ride-on toy, the three wheels are arranged in a tricycle arrangement with two of the wheels the head end 112 of the toy 100, and the remaining wheel at the tail end 114 of the toy 100. In other three-wheeled embodiments of the ride-on toy 100, the three wheels are arranged in a tricycle arrangement with two of the wheels at the tail end 114 of the toy 100, and the remaining wheel at the head end 112 of the toy 100.

Preferably, the ride-on toy 100 has four wheels 210, with two of the wheels at the head end 112 of the toy 100 and the remaining two wheels at the tail end 114 of the toy 100 to provide stability when the toy 100 is being ridden or pushed along the ground. Some embodiments of the ride-on toy 100 may have five, six, seven, or eight wheels, wherein some legs 200 share a central wheel 210 disposed between two of the lees.

In the walking mechanism, the axle is connected to the centre of the wheel 210 so as to provide a smooth ride when the toy 100 is rolled along flat ground. The foot 240 is linked to the wheel 210, for example by a pin 250 which connects the foot 240 to the wheel 210 away from the centre of the wheel 210 (i.e. the foot 240 is eccentrically linked to the wheel 210). As a result, rotation of the wheel 210 causes the pin 250 to orbit the wheel centre, and accordingly the foot 240 also moves in a circular path with the rotation of the wheel 210. In being substantially parallel to and axially offset from each other, the pin 250 and the axle may resemble and function as a cranked axle.

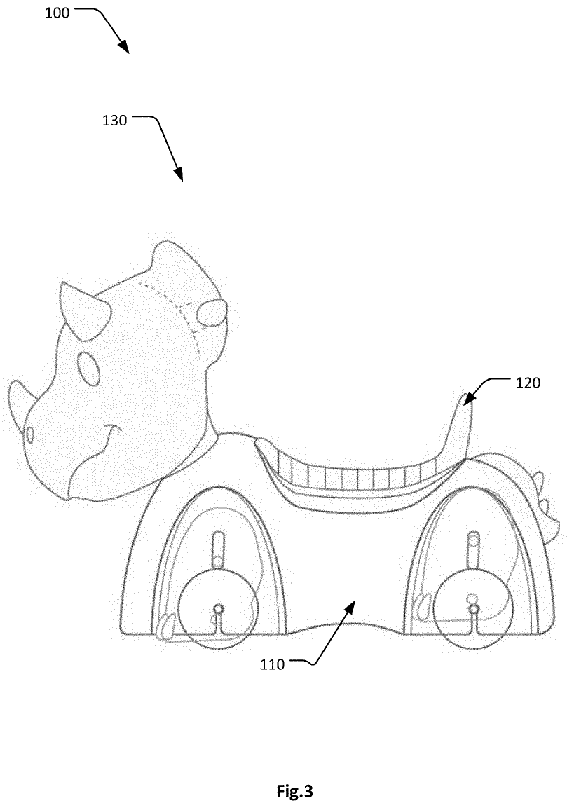

The movement of the foot causes the peg 225 to simultaneously slide in the slot 230. The slot 230 has a length substantially corresponding to the distance travelled by the pin 250 when the pin 250 completes half an orbit of the wheel centre, such as shown in FIG. 3. As a result, half a revolution of the wheel 210 causes the peg 225 to travel substantially the length of the slot 230. Multiple revolutions of the wheel 210 causes the peg 225 to shuttle along the length of the slot 230, in a reciprocating movement. In some embodiments, the slot 230 is substantially linear. The slot 230 may be arranged in a direction parallel to a radius of the wheel 210, such as perpendicular to a forward direction of travel of the toy 100 (i.e. vertical, when the toy 100 is placed on a horizontal surface).

The simultaneous orbiting movement of the pin 250 and the sliding movement of the peg 225 means that the movement of the foot 240 and the leg 220 provides the toy 100 with a gait generally resembling the gait of the creature or animal. Accordingly, when the walking mechanism 200 is attached to the body 110, the creature or animal (toy 100) appears to be “walking” when pushed forward.

Throughout the orbital movement of the foot 240 about the wheel centre as the wheel 210 rotates, the foot 240 remains offset from a ground-engaging portion of the wheel 210. This means that when the toy 100 is rolled along flat ground, only the wheels 210 come into contact with the ground.

In some embodiments, each one of the wheels 210 is independently rotatably mounted to the body 110, so that rotation of any one of the wheels 210 moves only the leg and foot connected to that wheel. In some embodiments, the front pair of legs may be configured so that both front legs move simultaneously. This may be achieved by the front wheels sharing a common axle. Similarly, the rear pair of legs may be configured so that both rear legs move simultaneously. In some embodiments, the front and rear pairs of legs move independent of each other.

In some embodiments, the front legs are identical and are mirror images of each other. Similarly, the rear legs are identical and are mirror images of each other.

In some embodiments, the seat 120 is fixedly connected to a midsection 116 of the body 110 defined between the head and tail ends 112, 114. The seat 120 may be movable between a seated position and a tilted position, wherein the seated position corresponds to the “rider” mode 130, and wherein the tilted position corresponds to the “walker” mode 115.

The seat 120 may be tilted by a hinge connection 260 at a first end of the seat 120. The seat 120 may be locked in the tilted position to prevent the seat 120 falling or being inadvertently lowered to the seated position. The locking may be provided for example by a ratchet system, or by a brace 820 (FIG. 8) which props the seat 120 in the tilted position, for example.

The seat 120 may be saddle shaped, and may comprise the handle 125. The handle 125 may be at an end remote to the hinged end. The seat 120 may be made from ABS. The seat 120 may act as a cover for a cavity or chamber defined by a solid upper part of the body 110, such that the seat closes the chamber when positioned down (in the “rider” mode). The chamber may be used for storage, for example.

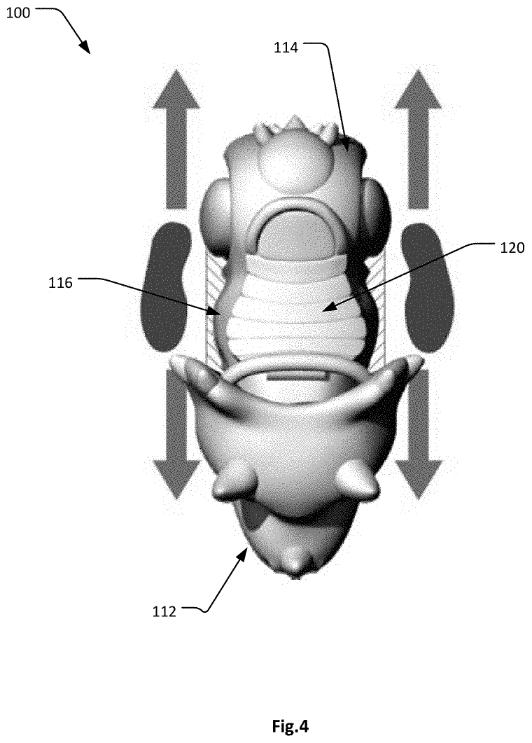

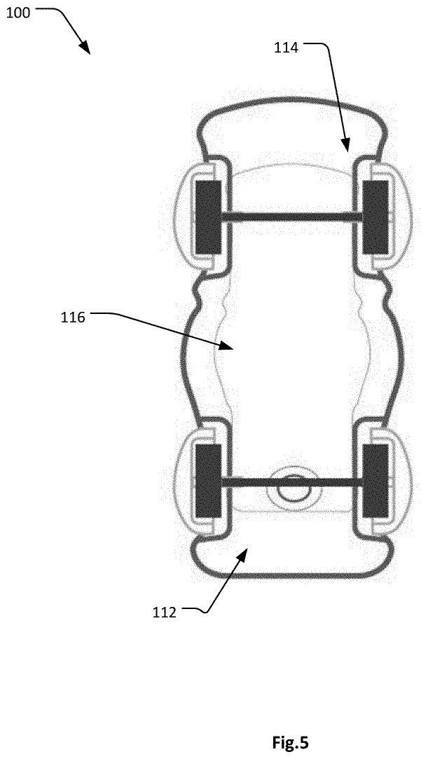

As shown in FIG. 4, a portion of the midsection between the front and rear legs is widened relative to the head and tail ends 112, 114 of the body. This forces the child's feet to be away from the body 110 and not in line with the wheels or legs. Each one of the wheels 210 is located between the body 110 and the foot 240 connected to that wheel 210. These features may reduce the likelihood of child's toes being run over while seated on the toy and pushing it along.

The body 110 may comprise recessed sections (FIG. 2) wherein the legs 240 are accommodated, to further define the widened midsection 116. Furthermore, the legs 220 may have flat pad areas under each foot 240, with no sharp or exposed edges.

The body 110 may be made from plastic such as ABS. ABS is stiffer than polypropylene (PP), which makes it easier to provide the desired structural rigidity. The plastic body may be rotationally moulded, injection moulded, or by a combination of processes. The body 110 may be shaped, coloured, and/or textured as required to resemble the creature or animal in question.

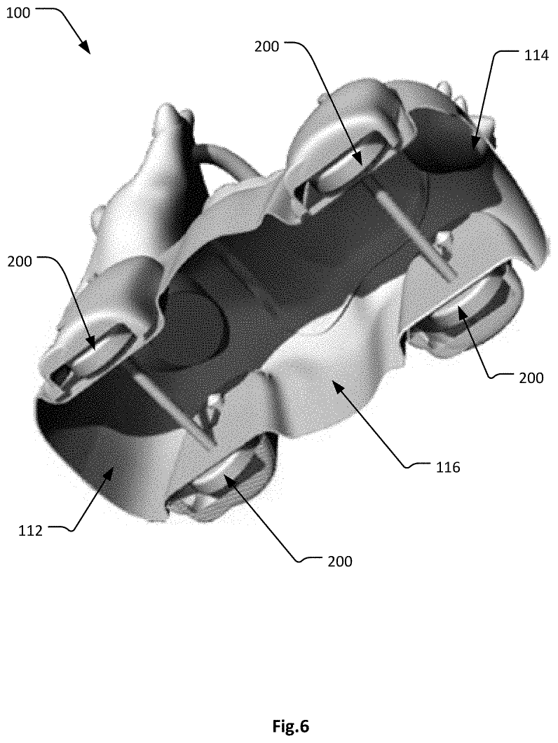

The body 110 may be made as a shell defining a hollow cavity, as shown in FIG. 6, and may comprise multiple pieces joined together. The body 110 may comprise various stiffeners. The body shell may have an average wall thickness between 2 mm and 6 mm, for example. In some embodiments, the body shell comprises at least one integrally moulded rib or stiffener to improve the structural integrity of the body shell.

The body 110 may be symmetric about an axis parallel to the direction of travel when the toy 100 is rolled along the ground.

The body 110 may comprise a plurality of holes to receive the axle for the wheels 210. A bushing may be installed at each hole to prevent the axle from wearing away the body material as the axle rotates. Each axle may be threaded through holes in the body, or pushed through a slot at the bottom of the body, for example as a press-fit (FIG. 3).

The length of the body 110 must be long enough to allow the child to comfortably sit on the toy 100. For example, the length of the body 110 may be between 400 mm and 600 mm. In some embodiments, the body 110 is approximately 464 mm long. The height of the body 110 is determined by the length of the child's legs. At least one of the child's legs must be able to contact the ground while the child is seated on the toy 100, so that the child may propel the toy 100 forwards or backwards by pushing off the ground with at least one of their legs. For example, the height of the body 110 may be between 200 mm and 300 mm. In some embodiments, the body is approximately 231 mm tall. Similarly, the width of the body 110 must allow the child to extend their legs around the body 110 to reach the floor when the child is seated on the toy 100. For example, the width of the body 110 may be between 150 mm and 250 mm. In some embodiments, the body 110 is approximately 213 mm wide.

The legs 220 may be made from a shell, as shown in FIG. 2. The legs 220 may be made from plastic, such as polypropylene (PP), which is softer than ABS. The leg shells may each have an average wall thickness between 2 mm and 6 mm, for example. In some embodiments, each leg shell comprises at least one integrally moulded rib or stiffener to improve the structural integrity of the body shell.

Referring again to FIG. 2, the toy 100 further comprises a head 270 of the creature or animal. The toy 100 may further comprise a tail 280 of the creature or animal. The head 270 is connected to the head end 112 of the body, and in embodiments comprising a tail 280, the tail 280 is connected to the tail end 114 of the body.

The head 270 and/or tail 280 may be connected to the body 110 by a snap-fit arrangement, such as matching plugs and sockets. The sockets may be circular, so that at least one of the head 270 and tail 280 may be pivotable relative to the body 110.

The head 270 may comprise a handle portion for the child to hold on to while seated on the toy 100. In some embodiments, the handle may be moulded and positioned to resemble the ears or other features of the creature or animal, such as the horns in FIG. 1B.

The wheels 210 may be made from plastic, such as polypropylene. In some embodiments the wheel is a solid disc with a central hole or centrally mounted bushing to receive the axle. In some embodiments, the wheel comprises a hub to receive the axle, the hub connected to a rim with spokes. The wheel rim may have some texture or tread for grip.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A ride-on toy, comprising:
a body having a shape resembling a torso of a creature and suitable for being sat on by a child; and
four walking mechanisms connected to the body, each walking mechanism comprising:
a wheel rotatably mounted to the body at a wheel centre; and
a leg slidably connected to the body via a peg received in a slot defined by the body, the leg comprising a foot and having a shape resembling a leg of the creature;
wherein the foot is eccentrically linked to the wheel; and
wherein rotation of the wheel is converted into orbital movement of the foot about the wheel centre and reciprocating movement of the leg along the slot;
wherein two out of the four walking mechanisms are connected to a head end of the body to define a pair of forelegs; and
wherein the other two out of the four walking mechanisms are connected to a tail end of the body to define a pair of hind legs.

2. The ride-on toy of claim 1, wherein each one of the wheels is independently rotatably mounted to the body, so that rotation of any one of the wheels moves only the leg and foot connected to that wheel.

3. The ride-on toy of claim 1, further comprising a seat connected to a midsection of the body defined between the head and tail ends, wherein the seat is movable between a seated position and a tilted position.

4. The ride-on toy of claim 3, wherein a portion of the midsection is widened relative to the head and tail ends of the body.

5. The ride-on toy of claim 3, wherein the seat comprises at least one handle for the child to hold on to for support while walking.

6. The ride-on toy of claim 1, further comprising a head of the creature and a tail of the creature, wherein the head is connected to the head end of the body, and wherein the tail is connected to the tail end of the body.

7. The ride-on toy of claim 6, wherein the head comprises a handle portion for the child to hold on to while seated on the toy.

8. The ride-on toy of claim 1, wherein throughout the orbital movement of the foot about the wheel centre as the wheel rotates, the foot remains offset from a ground-engaging portion of the wheel.

9. The ride-on toy of claim 1, wherein each one of the wheels is located between the body and the foot connected to that wheel.
